(19) United States
(12) Patent Application Publication
(10) Pub. No.: US 2006/0281654 A1
(43) Pub. Date: Dec. 14, 2006

(54) Detergent and bleach compositions

(76) Inventors: Anju Deepali Massey Brooker, Newcastle upon Tyne (GB); Alan Thomas Brooker, Newcastle upon Tyne (GB); Julie Ellis, Newcastle upon Tyne (GB); Nathalie Sophie Letzelter, Newcastle upon Tyne (GB); Andrew Paul Nelson, Newcastle upon Tyne (GB); Eric San Jose Robles, Newcastle upon Tyne (GB); Nigel Patrick Somerville Roberts, Newcastle upon Tyne (GB); Xinbei Song, Cincinnati, OH (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/441,478

(22) Filed: May 26, 2006

Related U.S. Application Data
(63) Continuation-in-part of application No. 11/369,593, filed on Mar. 7, 2006.

(30) Foreign Application Priority Data
Mar. 7, 2005 (EP) 05004971.7

(51) Int. Cl. C11D 3/00

(52) U.S. Cl. 510/375

(57) ABSTRACT

Detergent or bleach composition comprising a host-guest complex of diacyl and/or tetraacyl peroxide bleaching species in the form of an aggregate having a weight average particle size of at least 106 μm and an anti-deposition polymer.

### PRIORITY CLAIM

This application is a continuation-in-part claiming priority to U.S. Ser. No. 11/369,593, filed Mar. 7, 2006, which claims priority to European Patent Application No. 05004971.7, filed Mar. 7, 2005.

### TECHNICAL FIELD

The present invention relates to detergent and bleach compositions comprising a host-guest complex of diacyl and tetraacyl peroxide bleaching species and which have improved stability, formulation compatibility and bleaching performance.

### BACKGROUND OF THE INVENTION

A well recognized problem arising during modern fabric laundering operations is the tendency of some coloured fabrics to release dye into the laundry wash solution. The dye is then transferred onto other fabrics being washed therewith.

In dishwashing, especially machine dishwashing methods there exists a related problem, coloured/bleachable food soils, comprising natural dyestuffs, may be removed from soiled articles into the wash solution, and then may be redeposited from the wash solution onto other articles in the wash or onto the interior of the dishwashing machine.

The problem is particularly noticeable when the washload includes articles soiled by foods naturally containing significant levels of coloured dyestuff molecules, including for example tomato sauce and curry.

Articles in the wash, and areas of the interior of the dishwashing machine which are made of plastic material, are particularly susceptible to the deposition of coloured food soils from the wash liquor. Such soils can interact with the surface of the plastic substrates producing staining which can be very difficult to remove. Furthermore, it is difficult to remove colour stains from plastic which has been stained by direct contact with colour food.

Different solutions have been proposed to tackle the removal and deposition of coloured stains from plastic in a machine dishwashing method. WO 03/095598 relates to a process for removing coloured stains from plastic by treating the substrate in an ADW machine with an aqueous liquor having a peroxide value of 0.05 to 40 (peroxide components include terpenes). In WO 03/095599 the coloured stains from plastic are removed by treating the substrate with a composition comprising 3-phenyl-2-propenal and/or 3,7-dimethyl-2,6-octadien-1-al. WO 03/095602 presents another alternative process for removing coloured stains from plastic by treating the substrate with an aqueous composition comprising a hydrophobic component having a density in the range of 0.06 to 1 gram/cm3. Hydrophobic components include hydrocarbon oil and edible oil. Paraffin oil is the preferred hydrophobic component.

Diacyl and/or tetraacyl peroxide bleaching species may be used to inhibit the transfer of coloured/bleachable soils when employed in a laundry (WO 93/07086) or dishwashing (WO 95/19132) method. Such species are however intrinsically unstable above their melting points and are liable to self-accelerating thermal decomposition. To provide storage stability it is hence necessary to incorporate the diacyl and tetraacyl bleaching species as “guest” molecules in “host-guest complexes” in which the molecules of the bleaching species are individually separated from each other by their inclusion in the host receptor sites. The hosts may for example be inorganic or organic crystals having relatively open structures which provide sites that may be occupied by guest molecules, thus forming the host-guest complexes. Examples of suitable hosts include certain clathrates or inclusion compounds, including the urea clathrates and the cyclodextrins, particularly the beta-cyclodextrins. The hosts are most preferably water soluble, to enable effective release and dispersion of the bleaching species on introduction of the host-bleaching species complexes into an aqueous media, such as a wash solution. Urea clathrates of diacyl and tetraacyl bleaching species have been disclosed in both WO 93/07086 and WO 95/19132.

It has now been found that urea clathrates and other complexes of diacyl and tetraacyl bleaching species have a limited compatibility with some of the detergent formulations, the problem is more acute in the case of high alkalinity compositions and even worse if the composition is in a compacted or compressed form.

### SUMMARY OF THE INVENTION

According to the first aspect of the invention there is provided a detergent or bleach composition, preferably for use in automatic dishwashing, comprising a host-guest complex of diacyl and/or tetraacyl peroxide bleaching species in the form of an aggregate, preferably, the aggregate has a weight average particle size of at least 106 μm. The diacyl peroxide bleaching species is selected from diacyl peroxides of the general formula:
R¹—C(O)—OO—(O)C—R²
in which R¹ represents a C₆-C₁₈ alkyl group and R² represents an aliphatic group compatible with a peroxide moiety, such that R¹ and R² together contain a total of 8 to 30 carbon atoms; the tetraacyl peroxide bleaching species is selected from tetraacyl peroxides of the general formula:
R³—C(O)—OO—C(O)—(CH₂)n-C(O)—OO—C(O)—R³
which R³ represents a C₁-C₉ alkyl group and n represents an integer from 2 to 12; and

(b) an anti-deposition polymer selected from the group consisting of: unsaturated acids, copolymers of unsaturated acids, carboxylated polysaccharides, modified celluloses, modified polyethyleneimines, modified hexamethylenediamine, polyamino acids, and mixtures thereof.

It has been found that the host-guest complex is more storage stable and efficacious in the form of an aggregate than in the form of powder, as has been traditionally used. The term “aggregate” refers broadly to the secondary particles formed by aggregation of primary host-guest complex particles according to any of the well known powder-processing technique including granulation, agglomeration, extrusion, compaction, encapsulation, etc.

The use of an anti-deposition polymer gives an more even distribution of the host-guest complex resulting in a more uniform removal of bleachable/coloured stains.

Usually detergent compositions, even in solid form, comprise ingredients in liquid form such as surfactants and perfumes. Moreover, detergent compositions can pick-up moisture from the surrounding environment or moisture can be released from some of the ingredients. Without being bound by theory, it is believed that the liquid components can migrate and destabilize the host-guest complex, thereby releasing bleaching species, this can give rise to an autocatalytic reaction, destabilizing not only the bleach but also the bleach sensitive ingredients such as enzymes and perfumes. This destabilization seems to be promoted in the highly alkaline environment of the majority of detergents. Another cause of destabilization of the host-guest complex seems to be oxygen proceeding from the surrounding environment or released by some of the detergent ingredients.

It has also been found that good storage stability is achieved when the host-guest complex has an aggregate particle size of at least about 106 μm, preferably at least about 210 μm. Again, without wishing to be bound by theory, it is believed that this particle size minimizes the number of contact points of the complex with the surrounding detergent ingredients and the exposure of the complex to oxygen, thereby improving the stability of the composition.

In a preferred embodiment the aggregate has a density of at least about 500 g/l more preferably the aggregate has a density of at least about 600 g/l and even more preferably of at least about 700 g/l. High density particles have also been found to be more stable than similar particles of lower density.

In a preferred embodiment the bleaching species is a diacyl peroxide wherein R¹ and R² are both C₆-C₁₂ unsubstituted alkyl group, more preferred for use herein are diacyl peroxide wherein both is R¹ and R² are C8, C9, C10 or C11. Preferably, the host-guest complex is a urea clathrate. Apparently, the urea form a three-dimensional network of cavities in which the peroxide molecules are hosted, precluding the interaction between peroxide molecules and thereby reducing the instability of the peroxide. The urea is highly water soluble readily releasing the bleaching species into the cleaning liquor.

The host-guest complex can be very instable and susceptible to react with other components, both active ingredients and process aids of the composition, making the design of the aggregate particles a real challenge. In a preferred embodiment, the aggregate particles are substantially free of binder, by substantially free herein is meant that the particles comprise less than about 5%, preferably less than about 1% by weight of the aggregate of binder. Binder free aggregate can be made by compacting methods including tabletting.

According to another preferred embodiment, the aggregate particles comprise a host-guest complex stable binder. The stability of a binder is assessed according to the following method: a batch of aggregate particles consisting essentially of binder and urea clathrate/peroxide bleaching species is made. The aggregate particles comprise about 13% of active peroxide bleaching species and the bleaching species and urea are in a weight ratio of about 4:1. The freshly made batch is divided into two batches. The amount of available oxygen (AvO) in the aggregate particles of the first batch is measured a few minutes (eg, 5 minutes) after the particles have been made is determined by titration (as explained herein below). The aggregate particles of the second batch are stored at 32° C., 80% relative humidity for six weeks. The amount of AvO in the aggregate particles of the second batch is measured straight after the storage period. A binder is considered to be a host-guest complex stable binder if the difference between the amount of AvO in the aggregate particles of the first and second batch is less than 10%, preferably less than 5%. Sufficient number of measurements is taken to ensure reproducibility.

Suitable binders for use herein include materials with low hydrogen bonding capacity and low susceptibility to oxidation. It is preferred to avoid traditional binders such as polyethylene glycols, non-ionic surfactants and other ethoxylated materials. Preferred binders for use herein include low reactive materials, more preferably low reactive materials which are solid at ambient temperature and become liquid at temperatures from about 35° to about 60° C. Especially suitable binders for use herein include wax and fatty acids derivatives.

Another advantage of the aggregate of the invention is its solubility profile in water. In the host-guest complex the bleaching species is loosely trapped in cavities formed by the “host”, for example in the case of urea a three-dimensional network of cavities is formed, the cavities are occupied by molecules of the bleaching species. This structure avoids the formation of large associations of bleaching species. Because the bleaching species are in molecular form, they are readily available to perform their bleaching action once the aggregate is dispersed or dissolved.

In a preferred embodiment, the composition further comprises a cleaning surfactant. The compositions of the invention are preferably in powder or any other solid form. Preferably the level of surfactant is from about 1% to about 40% by weight of the composition. Usually the surfactant is in liquid or paste form and the level of surfactant is high, this may negatively affect the stability of the host-guest complex. This problem can be overcome or minimized by the use of a multi-compartment unit dose product such as a pouch, in which part or all of the surfactant can be placed in a different compartment to that in which the host-guest complex is located, reducing the host-guest complex/surfactant interaction, thereby improving the stability of the composition.

### DETAILED DESCRIPTION OF THE INVENTION

The present invention relates to detergent and bleaching compositions comprising a host-guest complex of diacyl and/or tetraacyl peroxide species of certain formula and an anti-deposition polymer. The compositions are preferably in solid or unit dose form, e.g., in powder, tablet or pouch form but can also be in liquid form. Liquid type compositions include formulations in which the liquid does not react with the host-guest complex, such as anhydrous formulations. The detergent compositions are particularly useful for automatic dishwashing and laundry, although other detergent applications are also envisaged. The bleaching composition can be used as additives, in combination with other detergent compositions or by themselves.

Diacyl and Tetraacyl Peroxide Bleaching Species

The diacyl peroxide bleaching species is selected from diacyl peroxides of the general formula:
R¹—C(O)—OO—(O)C—R²
in which R¹ represents a C₆-C₁₈ alkyl, preferably C₆-C₁₂ alkyl group containing a linear chain of at least 5 carbon atoms and optionally containing one or more substituents (e.g. —N⁺ (CH₃)₃, —COOH or —CN) and/or one or more interrupting moieties (e.g. —CONH— or —CH═CH—) interpolated between adjacent carbon atoms of the alkyl radical, and R² represents an aliphatic group compatible with a peroxide moiety, such that R¹ and R² together contain a total of 8 to 30 carbon atoms. In one preferred aspect R¹ and R² are linear unsubstituted C₆-C₁₂ alkyl chains. Most preferably R¹ and R² are identical. Diacyl peroxides, in which both R¹ and R² are C₆-C₁₂ alkyl groups, are particularly preferred.

The tetraacyl peroxide bleaching species is selected from tetraacyl peroxides of the general formula:
R³—C(O)—OO—C(O)—(CH₂)n-C(O)—OO—C(O)—R³
in which R³ represents a C₁-C₉ alkyl, preferably C₃-C₇, group and n represents an integer from 2 to 12, preferably 4 to 10 inclusive.

Preferably, the diacyl and/or tetraacyl peroxide bleaching species is present in an amount sufficient to provide at least 0.5 ppm, more preferably at least 10 ppm, and even more preferably at least 50 ppm by weight of the wash liquor. In a preferred embodiment, the bleaching species is present in an amount sufficient to provide from about 0.5 to about 60 ppm, more preferably from about 5 to about 30 ppm by weight of the wash liquor.

Particle Size Distribution

The bleaching aggregate of the invention has a weight average particle size (sometimes referred to as particle size) of at least about 106 μm, by this is meant that more than about 50% by weight of the aggregate particles are retained on a sieve having a mesh of 106 μm aperture (Sieve size No. 140, US mesh 105). Preferably, the particle size is at least about 210 μm, more preferably at least about 354 μm and even more preferably at least about 420 μm (ie, more than about 50% by weight of the aggregate particles will be retained on Sieve No. 70, US mesh 210; Sieve No. 45, US mesh 354; and Sieve No. 40, US mesh 420, respectively).

It is also preferred that no more than about 10%, more preferably no more than about 5% by weight of the aggregate particles pass through a 37 μm mesh (Sieve size No. 400, US mesh 37). It is also preferred that more than about 90%, preferably more than about 95% by weight of the aggregate particles go through a Sieve No. 18, US mesh 1000; more preferably through a Sieve No. 20, US mesh 841.

Aggregate Density

The density of the aggregate is measured by volume displacement. A graduated cylinder is filled with a liquid of known density in which the aggregate is not soluble, for example paraffin, up to a known volume. A known weight of aggregate is added to the liquid and the increase in volume is measured. The measurement is performed at room temperature (liquid and aggregate being at room temperature). The density of the aggregate is calculated by dividing the aggregate mass by the increase in volume. The density of the liquid is used to adjust this calculation.

AvO Determination Method

A 0.5 g sample of aggregate particles is placed into a 150 ml beaker, 60 ml of isopropanol is added and the mixture is warmed to achieve dissolution. 10 ml of glacial acetic acid and 7 g of solid potassium iodine are added, stirred and heated at 60° C. for 10 min. The resulting mixture is covered and placed in the dark for 5 min. The mixture is topped up with isopropanol up to 100 ml and tritrated with 0.1 N sodium thiosulphate. The titration can be carried out with an autotritrator and electrochemical detection using a Mettler DM 140-SC electrode. A blank is prepared using the same reagents. The AvO is calculated as follows:
% AvO=(titration−blank)×0.1×16×100/(0.5×2000)
Binders

Materials suitable for use as binder in the particles of the composition of the invention must have a number of characteristics. Thus, the material must be chemically compatible with the host-guest complex and should have a suitable release profile, especially an appropriate melting point range. The melting point range is preferably from about 35° C. to about 60° C., more preferably from about 40° C. to about 50° C. Paraffin waxes, microcrystalline waxes and natural waxes give good results. Some preferred paraffin waxes include Merck® 7150 and Merck® 7151 supplied by E. Merck of Darmstadt, Germany; Boler® 1397, Boler® 1538 and Boler® 1092 supplied by Boler of Wayne, Pa; Ross® fully refined paraffin wax 115/120 supplied by Frank D. Ross Co., Inc of Jersey City, N.J.; Tholler® 1397 and Tholler®1538 supplied by Tholler of Wayne, Pa.; Paramelt® 4608 supplied by Terhell Paraffin of Hamburg, Germany and Paraffin® R7214 supplied by Moore & Munger of Shelton, Conn.

Natural waxes, such as natural bayberry wax, m.pt. 42° C.-48° C. supplied by Frank D. Ross Co., Inc, are also useful as are synthetic substitutes of natural waxes such as synthetic spermaceti wax, m.pt. 42° C.-50° C., supplied by Frank D. Ross Co., Inc., synthetic beeswax (BD4) and glyceryl behenate (HRC) synthetic wax.

Other options for the binders are fatty acids, especially hydrogenated fatty acids. Most preferred binders for use herein are paraffin waxes.

Process for Preparing the Aggregate

A variety of methods may be employed to prepare the host-guest complex of diacyl and/or tetraacyl peroxide aggregate particles. These methods include agglomeration, compaction, extrusion, etc. In a preferred method the particles are prepared using a compaction process in the absence of binders.

Another preferred method is extrusion. The host-guest complex of diacyl and/or tetraacyl peroxide is mixed with a low host-guest complex stable binder to ensure that the resulting mixture become extrudable under pressure. The mixture is extruded to form a strand and, after leaving the extrusion die, the strand thus formed is chopped into pieces of predetermined size by means of a cutting unit. The resulting pieces can be shaped using any shaping process such as spheronization.

The host-guest complex may further comprise an anti-deposition polymer or may be mixed with other particles or pastes, liquids and slurries containing the anti-deposition polymer.

Anti-Deposition Polymer

The composition comprises from about 0.01% to about 4% by weight of an anti-deposition polymer selected from unsaturated acids, copolymers of unsaturated acids, carboxylated polysaccharides, modified celluloses, modified polyethyleneimines, modified hexamethylenediamine, polyamino acids, and mixtures thereof.

The degree of polymerization for these materials, which is most easily expressed in terms of weight average molecular weight, is not critical provided the material has the desired water solubility and soil anti-deposition power. Suitable polymers will also, generally, have a water solubility of greater than 0.3% at normal usage temperatures. In certain embodiments, a dispersant polymer may be present in an amount in the range from about 0.01% to about 4%, or from about 0.1% to about 4%, and alternatively, from about 0.1% to about 4% by weight of the composition.

Any suitable anti-deposition polymer in any suitable amount may be used. Suitable polymers include unsaturated acids that can be polymerized including acrylic acid, methacrylic acid, maleic acid (or maleic anhydride), fumaric acid, itaconic acid, aconitic acid, mesaconic acid, citraconic acid and methylenemalonic acid. Copolymer of the unsaturated acids are also suitable, include co-unsaturated acids (e.g., acrylic acid and maleic acid) and unsaturated acids with other comonomers such as styrene. The molecular weight of the polymer can vary over a wide range, for instance from about 1000 to about 500,000, alternatively from about 1000 to about 250,000. Further suitable dispersant polymers derived from unsaturated monomeric acids include, but are not limited to those disclosed in U.S. Pat. No. 3,308,067; U.S. Pat. No. 3,308,067; U.S. Pat. No. 4,379,080 U.S. Pat. No. 4,530,766, U.S. Pat. No. 5,084,535; and EP 0 066 915.

Suitable for use as a polymer herein are co-polymers synthesized from acrylic acid, maleic acid and methacrylic acid such as ACUSOL® 480N supplied by Rohm & Haas and polymers containing both carboxylate and sulphonate monomers, such as ALCOSPERSE® polymers (supplied by Alco).

In one embodiment an ALCOSPERSE® polymer sold under the trade name ALCOSPERSE® 725, is a co-polymer of Styrene and Acrylic Acid with the following structure:

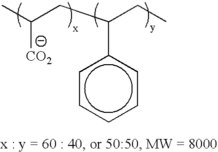

Suitable polymers also include the carboxylated polysaccharides, particularly starches, celluloses and alginates, described in U.S. Pat. No. 3,723,322; the dextrin esters of polycarboxylic acids disclosed in U.S. Pat. No. 3,929,107; the hydroxyalkyl starch ethers, starch esters, oxidized starches, dextrins and starch hydrolysates described in U.S. Pat. No. 3,803,285; the carboxylated starches described in U.S. Pat. No. 3,629,121; and the dextrin starches described in U.S. Pat. No. 4,141,841.

Suitable cellulose polymers include, but are not limited to: cellulose sulfate esters (for example, cellulose acetate sulfate, cellulose sulfate, hydroxyethyl cellulose sulfate, methylcellulose sulfate, hydroxypropylcellulose sulfate, and mixtures thereof), sodium cellulose sulfate, carboxymethyl cellulose, and mixtures thereof.

Suitable polymers also include modified hexamentylenediamine. The modification of the hexamentylenediamine includes: (1) one or two alkoxylation modifications per nitrogen atom of the hexamentylenediamine. The alkoxylation modification consisting of the replacement of a hydrogen atom on the nitrogen of the hexamentylenediameine by a (poly)alkoxylene chain having an average of about 1 to about 40 alkoxy moieties per modification, wherein the terminal alkoxy moiety of the alkoxylene chain is capped with hydrogen, a C₁-C₄ alkyl, sulfates, carbonates, or mixtures thereof; (2) a substitution of one C₁-C₄ alkyl moiety and one or two alkoxylation modifications per nitrogen atom of the hexamentylenediamine. The alkoxylation modification consisting of the replacement of a hydrogen atom by a (poly)alkoxylene chain having an average of about 1 to about 40 alkoxy moieties per modification wherein the terminal alkoxy moiety of the alkoxylene chain is capped with hydrogen, a C₁-C₄ alkyl or mixtures thereof; or (3) a combination thereof. The alkoxylation may be in the form of ethoxy, propoxy, butoxy or a mixture thereof. U.S. Pat. No. 4,597,898,

A preferred modified hexamethylenediamine has the general structure below: 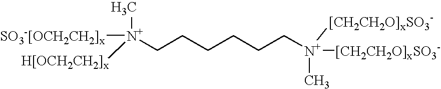
wherein x is from about 20 to about 30 and approximately 40% of the (poly)alkoxylene chain terminal alkoxy moieties are sulfonated.

A preferred modified hexamethylenediamine has the general structure below: 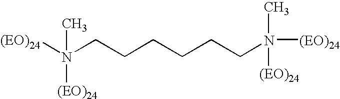
available under the tradename LUTENSIT® from BASF and such as those described in WO 01/05874.

Further suitable polymers are polyamino acids that may be derived from L-glumatic acid, D-glumatic acid or mixtures, e.g. racemates, of these L and D isomers. The polymers include not only the homopolymers of glutamic acid but also copolymers, such as block, graft or random copolymers, containing glutamic acid. These include, for example, copolymers containing at least one other amino acid, such as aspartic acid, ethylene glycol, ethylene oxide, (or an oligimer or polymer of any of these) or polyvinyl alcohol. Glutamic acid can, of course, carry one or more substituents including, for example, alkyl, hydroxy alkyl, aryl and arylalkyl, commonly with up to 18 carbon atoms per group, or polyethylene glycol attached by ester linkages. See U.S. Pat. No. 5,470,510 A, issued Nov. 28, 1995.

The detergent and bleaching compositions herein may further comprise traditional detergency components. The compositions, especially the detergent compositions, will generally be built and comprise one or more detergent active components which may be selected from colorants, additional bleaching agents, surfactants, alkalinity sources, enzymes, anti-corrosion agents (e.g. sodium silicate) and disrupting agents (in the case of powder, granules or tablets). Highly preferred detergent components include a builder compound, an alkalinity source, a surfactant, an enzyme and a bleaching agent. Preferably, the compositions of the invention comprise an additional bleaching agent in addition to the diacyl and/or tetraacyl peroxide. Preferably the additional bleaching agent is a percarbonate, in a level of from about 1% to about 80% by weight of the composition, in the case of a detergent composition the level is from about 2% to about 40%, more preferably from about 3% to about 30% by weight of the composition.

Preferably, the compositions of the invention comprise a cleaning surfactant and a surfactant acting as a suds suppressor. Preferably the total surfactant is present in an amount sufficient to provide at least about 50 ppm, more preferably at least about 100 ppm and even more preferably at least about 400 ppm by weight of the wash liquor.

Cleaning Surfactant

The cleaning surfactant can be a single surfactant or a mixture thereof, preferably including one or more cleaning surfactants having a cloud point above wash temperature i.e., preferably above about 40° C., more preferably above about 50° C. and even more preferably above about 60° C. “Cloud point”, as used herein, is a well known property of surfactants and mixtures thereof which is the result of the surfactant becoming less soluble with increasing temperature, the temperature at which the appearance of a second phase is observable is referred to as the “cloud point” (See KirkOthmer's Encyclopedia of Chemical Technology, 3rd Ed., Vol. 22, pp. 360-362).

Preferred cleaning surfactants for use herein include both liner and branched alkyl ethoxylated condensation products of aliphatic alcohols with an average of from about 4 to about 10, preferably form about 5 to about 8 moles of ethylene oxide per mol of alcohol are suitable for use herein. The alkyl chain of the aliphatic alcohol generally contains from about 6 to about 15, preferably from about 8 to about 14 carbon atoms. Particularly preferred are the condensation products of alcohols having an alkyl group containing from about 8 to about 13 carbon atoms with an average of from about 6 to about 8 moles of ethylene oxide per mole of alcohol. Preferably at least 25%, more preferably at least 75% of the surfactant is a straight-chain ethoxylated primary alcohol. It is also preferred that the HLB (hydrophilic-lipophilic balance) of the surfactant be less than about 18, preferably less than about 15 and even more less than 14. Preferably, the surfactant is substantially free of propoxy groups. Commercially available products for use herein include LUTENSOL®TO series, C13 oxo alcohol ethoxylated, supplied by BASF, especially suitable for use herein being LUTENSOL®TO7.

Amine oxides surfactants are also useful as cleaning surfactants in the present invention and include linear and branched compounds having the formula: 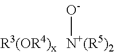
wherein R³ is selected from an alkyl, hydroxyalkyl, acylamidopropoyl and alkyl phenyl group, or mixtures thereof, containing from 8 to 26 carbon atoms, preferably 8 to 18 carbon atoms; R⁴ is an alkylene or hydroxyalkylene group containing from 2 to 3 carbon atoms, preferably 2 carbon atoms, or mixtures thereof; x is from 0 to 5, preferably from 0 to 3; and each R⁵ is an alkyl or hydroxyalkyl group containing from 1 to 3, preferably from 1 to 2 carbon atoms, or a polyethylene oxide group containing from 1 to 3, preferable 1, ethylene oxide groups. The R⁵ groups can be attached to each other, e.g., through an oxygen or nitrogen atom, to form a ring structure.

These amine oxide surfactants in particular include C₁₀-C₁₈ alkyl dimethyl amine oxides and C₈-C₁₈ alkoxy ethyl dihydroxyethyl amine oxides. Examples of such materials include dimethyloctylamine oxide, diethyldecylamine oxide, bis-(2-hydroxyethyl)dodecylamine oxide, dimethyldodecylamine oxide, dipropyltetradecylamine oxide, methylethylhexadecylamine oxide, dodecylamidopropyl dimethylamine oxide, cetyl dimethylamine oxide, stearyl dimethylamine oxide, tallow dimethylamine oxide and dimethyl-2-hydroxyoctadecylamine oxide. Preferred are C₁₀-C₁₈ alkyl dimethylamine oxide, and C₁₀-C₁₈ acylamido alkyl dimethylamine oxide.

Suds Suppresser

The surfactants for use as suds suppressers are preferably non-ionic surfactants having a low cloud point. As used herein, a “low cloud point” non-ionic surfactant is defined as a non-ionic surfactant system ingredient having a cloud point of less than 30° C., preferably less than about 20° C., and even more preferably less than about 10° C., and most preferably less than about 7.5° C. Typical low cloud point non-ionic surfactants include non-ionic alkoxylated surfactants, especially ethoxylates derived from primary alcohol, and polyoxypropylene/polyoxyethylene/polyoxypropylene (PO/EO/PO) reverse block polymers. Also, such low cloud point non-ionic surfactants include, for example, ethoxylated-propoxylated alcohol (e.g., Olin Corporation's POLY-TERGENT® SLF18) and epoxy-capped poly(oxyalkylated) alcohols (e.g., Olin Corporation's POLY-TERGENT® SLF18B series of non-ionics, as described, for example, in U.S. Pat. No. 5,576,281).

Other suitable low cloud point surfactants are the ether-capped poly(oxyalkylated) suds suppresser having the formula: 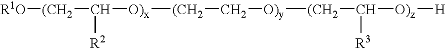
wherein R¹ is a linear, alkyl hydrocarbon having an average of from about 7 to about 12 carbon atoms, R² is a linear, alkyl hydrocarbon of about 1 to about 4 carbon atoms, R³ is a linear, alkyl hydrocarbon of about 1 to about 4 carbon atoms, x is an integer of about 1 to about 6, y is an integer of about 4 to about 15, and z is an integer of about 4 to about 25.

Other low cloud point non-ionic surfactants are the ether-capped poly(oxyalkylated) having the formula:
R₁O(R_{II}O)ₙCH(CH₃)OR_{III}
wherein, R¹ is selected from the group consisting of linear or branched, saturated or unsaturated, substituted or unsubstituted, aliphatic or aromatic hydrocarbon radicals having from about 7 to about 12 carbon atoms; R^{II} may be the same or different, and is independently selected from the group consisting of branched or linear C₂ to C₇ alkylene in any given molecule; n is a number from 1 to about 30; and R^{III} is selected from the group consisting of:
(i) a 4 to 8 membered substituted, or unsubstituted heterocyclic ring containing from 1 to 3 hetero atoms; and
(ii) linear or branched, saturated or unsaturated, substituted or unsubstituted, cyclic or acyclic, aliphatic or aromatic hydrocarbon radicals having from about 1 to about 30 carbon atoms;
(b) provided that when R² is (ii) then either: (A) at least one of R¹ is other than C₂ to C₃ alkylene; or (B) R² has from 6 to 30 carbon atoms, and with the further proviso that when R² has from 8 to 18 carbon atoms, R is other than C₁ to C₅ alkyl.

If non-ionic suds suppressers are used they are preferably used in a level of from about 5% to about 40%, preferably from about 8% to about 35% and more preferably form about 10% to about 25% by weight of the composition.

The cleaning surfactant is preferably used in the compositions of the invention at a level of from about 2% to about 30%, more preferably from about 4% to about 25% and even more preferably form about 3% to about 20% by weight of the composition. It is also preferred that the ethoxylated alcohols, the amine oxide surfactants and the mixtures thereof, if present, are in a level of at least about 2%, more preferably about 3% by weight of the composition. In preferred embodiments the ethoxylated alcohols are in a level above about 3%, more preferably above about 4% by weight of the composition.

Especially preferred is the case in which the cleaning surfactant comprises an ethoxylated alcohol and the alcohol and suds suppressor are in a weight ratio of at least about 1:1, more preferably about 1.5:1 and even more preferably about 1.8:1. This is preferred from a performance point of view.

Also preferred are compositions in which the total surfactant and the bleaching species are in a weight ratio of at least about 3:1, more preferably at least about 5:1 and even more preferably in a weight ratio of at least about 8:1, these ratios guarantee an optimum performance of the bleaching species.

In the multi-compartment pouch and unit dose embodiments, the liquid composition can comprise organic solvents having a cleaning and/or a carrier or diluent function or some other specialised function.

Chelating Agents

Transition-metal selective sequestrants, “chelants” or “chelating agents”, e.g., iron and/or copper and/or manganese chelating agents are also suitable for use herein. Chelating agents suitable for use herein can be selected from the group consisting of aminocarboxylates, phosphonates (especially the aminophosphonates), polyfunctionally-substituted aromatic chelating agents, and mixtures thereof.

Aminocarboxylates useful as optional chelating agents are further illustrated by ethylenediaminetetracetates, N-hydroxyethylethylenediaminetriacetates, nitrilo-triacetates, ethylenediamine tetraproprionates, triethylenetetraaminehexacetates, diethylenetriamine-pentaacetates, and ethanoldiglycines, alkali metal, ammonium, and substituted ammonium salts thereof. In general, chelant mixtures can be used for a combination of functions, such as multiple transition-metal control, long-term product stabilization, and/or control of precipitated transition metal oxides and/or hydroxides.

Polyfunctionally-substituted aromatic chelating agents are also useful in the compositions herein. See U.S. Pat. No. 3,812,044, issued can 21, 1974, to Connor et al. Preferred compounds of this type in acid form are dihydroxydisulfobenzenes such as 1,2-dihydroxy-3,5-disulfobenzene.

A highly preferred biodegradable chelator for use herein can be ethylenediamine disuccinate (“EDDS”), especially (but not limited to) the [S, S] isomer as described in U.S. Pat. No. 4,704,233, Nov. 3, 1987, to Hartman and Perkins. The trisodium salt can be preferred though other forms, such as magnesium salts, can also be useful.

Aminophosphonates are also suitable for use as chelating agents in the compositions of the invention when at least low levels of total phosphorus are acceptable in detergent compositions, and include the ethylenediaminetetrakis(methylenephosphonates) and the diethylenetriaminepentakis(methylene phosphonates). Preferably, these aminophosphonates do not contain alkyl or alkenyl groups with more than about 6 carbon atoms.

If utilized, chelating agents or transition-metal-selective sequestrants will preferably comprise from about 0.001% to about 10%, more preferably from about 0.05% to about 1% by weight of the compositions herein.

Multi-Compartment Dosage Forms

In a preferred embodiment of the present invention the composition is in the form of a multi-phase unit dose product, preferably a vacuum or thermoformed multi-compartment water-soluble pouch, wherein one of the compartments, preferably a compartment containing a solid composition comprises the host-guest complex. Preferred manufacturing methods for unit dose executions are described in WO 02/42408. Any water-soluble film-forming polymer which is compatible with the compositions of the invention and which allows the delivery of the composition into the main-wash cycle of a dishwasher or laundry washing machine can be used as enveloping material.

Single compartment pouches can be made by placing a first piece of film in a mould, drawing the film by vacuum means to form a pocket, filling the formed pocket with a detergent or bleach including the guest-host complex, and placing and sealing the formed pocket with another piece of film.

The multi-compartment pouches of the invention can be made by placing a first piece of film in a mould, drawing the film by vacuum means to form a pocket, pinpricking the film, dosing and tamping the powder composition comprising the host-guest complex, placing a second piece of film over the first pocket to form a new pocket, filling the new pocket with the liquid composition, placing a piece of film over this liquid filled pocket and sealing the three films together to form the dual compartment pouch.

### EXAMPLES

Abbreviations Used in Examples

In the examples, the abbreviated component identifications have the following meanings:

| | |
|---|---|
| Carbonate | Anhydrous sodium carbonate |
| STPP | Sodium tripolyphosphate |
| Silicate | Amorphous Sodium Silicate (SiO₂:Na₂O = |
| | from 2:1 to 4:1) |
| Percarbonate | Sodium percarbonate of the nominal formula |
| | 2Na₂CO₃.3H₂O₂ |
| Amylase | α-amylase available from Novo Nordisk A/S |
| Protease | protease available from Genencor |
| SLF18 | Poly-Tergent ® available from BASF |
| Alcosperse 240 | sulfonated polymer available from Alco Chemical |
| DPG | dipropylene glycol |
| Polygel DKP | Polyacrylate thickener from ex 3V Co. |

In the following examples all levels are quoted as per cent (%) by weight.

Composition A (comprising the amount of host-guest complex aggregate particles indicated in A1) is introduced into a dual superposed compartment PVA rectangular base pouch. The dual compartment pouch is made from a Monosol M8630 film as supplied by Chris-Craft Industrial Products. 18 g of the solid composition and 2 g of the liquid composition are placed in the two different compartments of the pouch. The pouch is manufactured by making an open pocket with a PVA film, filling it with the solid composition, placing a PVA film over the open pocket and sealing the two films to create a new open pocket, the new pocket is filled with the liquid composition, a piece of PVA is placed over it and the new pocket is sealed giving rise to a dual compartment pouch. Similarly, pouches are made comprising composition A and the amount of host-guest complex particles indicated in A2-A4.

The compositions are stable stored for 6 weeks, at 32° C. and 80% relative humidity.

Agglomerate Aggregates

Particles comprising 80% of DAP clathrate (dioctanoyl acyl peroxide of formula (CH3(CH2)7C(O)OOC(O)(CH2)7CH3 as urea clathrate, wherein the peroxide and the urea are in a weight ratio of about 4:1) and 20% of paraffin wax are made as follows: 160 g of DAP powder is placed in a heat proof container and the molten wax is slowly added whilst mixing at moderate to high speeds until agglomeration takes place. The resulting particles are screened. The oversized particles are further broken and re-screened and the fines are added to the mixture whilst adding the remaining molten wax until a particle size of at least 106 =82 m is achieved.

Compacted Aggregates

100% DAP clathrate particles (dioctanoyl acyl peroxide of formula (CH₃(CH₂)₇C(O)OOC(O)(CH₂)₇CH₃ as urea clathrate, wherein the peroxide and the urea are in a weight ratio of about 4:1) are made as follows:

60 g DAP clathrate powder is placed in a 54 mm tablet die and compacted using an Instron using 50 k N force, 20 mm/min speed. The tablet is released from the mould and broken into pieces using a heavy object eg., a pestle. The resulting particles are screened, the oversized are further broken and re-screened and the fines re-compacted until a particle size of at least 106 μm is achieved.

| | A |
|---|---|
| Particulate composition | |
| Anhydrous STPP | 35 |
| Sodium Silicate | 4 |
| Sodium Carbonate | 26 |
| Host-guest aggregate | See below |
| Amylase | 1 |
| Protease | 2 |
| Percarbonate | 20 |
| SLF18 | 1.5 |
| Perfume | 0.2 |
| Alcosperse 240 | 3 |
| Mis/moisture to balance | To 100 |
| Liquid composition | |
| DPG | 40 |
| Glycerine | 3 |
| SLF18 | 46.6 |
| Dye | 0.8 |
| Water to balance | To 100 |

Host-guest aggregate

| | A1 | A2 | A3 | A4 |
|---|---|---|---|---|
| Agglomerate | 5 | | 3.125 | |
| Compacted | | 4 | | 2 |

Compositions D-I are gel and powder formulation examples according the present invention.

| | B | C | D | E |
|---|---|---|---|---|
| | Gel | Gel | Powder | Powder |
| STPP | 15 | 20.5 | 16 | 27.44 |
| Polygel DKP | 1 | 1.2 | — | — |
| Host-guest | 0.01-5 | 0.01-5 | 0.01-5 | 0.01-5 |
| aggregate¹ | | | | |
| Anti-deposition | 0.1-4 | 0.1-4 | 0.1-4 | 0.1-4 |
| polymer² | | | | |
| SLF18 | — | 1 | 0.8 | 1.76 |
| ALCOSPERSE ® | — | — | — | 2.27 |
| 246 | | | | |
| hydrozincite | 0.12 | — | — | — |
| Zinc sulfate | — | 0.67 | — | — |
| Nitric acid (70%) | 0.02 | 0.02 | — | — |
| Sulfuric acid | — | 4.23 | — | — |
| NaOH | 2.3 | — | — | — |
| KOH | — | 13.04 | — | — |
| carbonate | — | — | 29.89 | 29.89 |
| 2.0r silicate | 19.37 | — | 12.25 | 8.98 |
| Sodium | 6.30 | — | — | — |
| hypochloride | | | | |
| Enzyme system | — | 0.76 | 0.77 | 1.86 |
| 1,2-propanediol | — | 0.72 | — | — |
| Boric acid | — | 3 | — | — |
| Sodium perborate | — | — | 3.6 | 4.25 |
| monohydrate | | | | |
| Calcium chloride | — | 0.22 | — | — |
| Sodium benzoate | 2 | 0.2 | — | — |
| Sodium sulfate | — | — | 34.2 | 21.49 |
| Water, perfume | Balance | Balance | to Balance | Balance |
| and minor | to 100 | 100 | to 100 | to 100 |
| ingredients | | | | |

1. as described above for the present invention.

2. the anti-deposition polymer described above suitable for the present invention.

Automatic Dishwashing Cleaning composition

| | F | G |
|---|---|---|
| | Gel (wt %) | Powder (wt %) |
| STPP | 0-30 | 0-30 |
| Polygel DKP | 1-2 | — |
| Host-guest | 0.01-5 | 0.01-5 |
| aggregate¹ | | |
| Anti-deposition | 0.1-4 | 0.1-4 |
| polymer² | | |
| SLF18 | 0-2 | 0.5-2 |
| ALCOSPERSE ® | — | 0-5 |
| 246 | | |
| Catechol³ | 0.1-6 | 0.1-6 |
| hydrozincite | 0-0.3 | — |
| Zinc sulfate | 0-0.8 | — |
| Nitric acid (70%) | 0.01-0.05 | — |
| Sulfuric acid | 0-5 | — |
| NaOH | 0-4 | — |
| KOH | 0-15 | — |
| carbonate | — | 25-35 |
| 2.0r silicate | 0-20 | 7-15 |
| Sodium | 0-8 | — |
| hypochloride | | |
| Enzyme system⁴ | 0-1 | 0.5-3 |
| 1,2-propanediol | 0-1 | — |
| Boric acid | 0-4 | — |
| Sodium perborate | — | 2-6 |
| monohydrate | | |
| Calcium chloride | 0-0.5 | — |
| Sodium benzoate | 0.1-6 | — |
| Sodium sulfate | — | 20-35 |
| Water, perfume | Balance to 100 | Balance to 100 |
| and other | | |
| components | | |

1. as described above for the present invention.
2. the anti-deposition polymer described above suitable for the present invention.
3. Catechol
4. one or more enzymes such as protease, mannaway, natalase, lipase and mixture thereof.

The efficacy of the compositions of the invention is tested by washing 2 rubber-maid spatulas stained with RAGU® original sauce in a Bosch 6032 dishwasher. The spatulas are pre-stained by placing them into the dishwasher on the 65E cycle with 100 g of RAGU® original sauce added into the main-wash.

The two pre-stained spatulas are placed in the cutlery basket of a Bosch 6032 dishwasher. One of compositions A-G is placed into the dispenser of the dishwasher. The 65E cycle is run. 40 g or RAGU® original sauce is added at the start of the main wash. Excellent and uniform cleaning performance is achieved.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A detergent or bleach composition comprising a host-guest complex of diacyl and/or tetraacyl peroxide bleaching species in the form of an aggregate having a weight average particle size of at least 106 μm wherein the diacyl peroxide bleaching species is selected from diacyl peroxides of the general formula:
R¹—C(O)—OO—(O)C—R²
in which R¹ represents a C₆-C₁₈ alkyl group and R² represents an aliphatic group compatible with a peroxide moiety, such that R¹ and R² together contain a total of 8 to 30 carbon atoms; the tetraacyl peroxide bleaching species is selected from tetraacyl peroxides of the general formula:
R³—C(O)—OO—C(O)—(CH₂)n-C(O)—OO—C(O)—R³
in which R³ represents a C₁-C₉ alkyl group and n represents an integer from 2 to 12; and an anti-deposition polymer selected from the group consisting of: unsaturated acids, copolymers of unsaturated acids, carboxylated polysaccharides, modified celluloses, modified polyethyleneimines, modified hexamethylenediamine, polyamino acids, and mixtures thereof.

2. A composition according to claim 1 wherein the anti-deposition polymer is selected from a acrylic acid copolymer with the group selected from maleic, styrene and mixtures thereof.

3. A composition according to claim 1 wherein the bleaching species is a diacyl peroxide wherein R¹ and R² are both C₆-C₁₂ unsubstituted alkyl group.

4. A composition according to claim 1 wherein the host-guest complex is a urea clathrate.

5. A composition according to claim 1 wherein the aggregate is substantially free of binder.

6. A composition according to claim 1 wherein the particles comprise a host-guest complex stable binder.

7. A composition according to claim 2 wherein the anti-deposition polymer an acrylic acid copolymer with styrene the following structure: 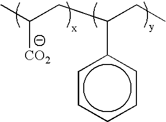
wherein the ratio of x : y is from 60:40 to 40:60 and a molecular weight from 4000 to 12000.

8. A composition according to claim 1 further comprising a soil removal surfactant.

9. A composition according to claim 1 wherein the composition is in the form of a multi-compartment pouch comprising a compartment containing a powder comprising the host-guest complex and another compartment containing a liquid comprising a surfactant.

10. A composition according to claim 7 wherein the anti-deposition polymer has the ratio of x:y selected from 60:40 or 50:50.
